(19) United States
(12) Patent Application Publication
(10) Pub. No.: US 2024/0224099 A1
(43) Pub. Date: Jul. 4, 2024

(54) CONTROL PLANE TRANSPORT SLICE IDENTIFIER FOR END-TO-END 5G NETWORK SLICING

(71) Applicant: RAKUTEN MOBILE, INC., Tokyo (JP)

(72) Inventors: Amit DHAMIJA, Karnataka (IN); Praveen KUMAR, Indore (IN)

(73) Assignee: RAKUTEN MOBILE, INC., Tokyo (JP)

(21) Appl. No.: 17/912,180

(22) PCT Filed: May 17, 2022
(86) PCT No.: PCT/US2022/029566

§ 371 Date: Nov. 23, 2023

(51) Int. Cl. H04W 24/10; H04L 41/5025; H04W 28/24

(52) U.S. Cl. CPC H04W 24/10; H04L 41/5025; H04W 28/24

(57) ABSTRACT

Provided are methods and apparatuses for monitoring performance of network slices in a transport network by a network controller and/or a network device. In an embodiment, the method includes transmitting, to a network device of the transport network using a path computation element communication protocol (PCEP), a PCEP configuration message requesting rendering of a transport network path assigned to a transport network slice. The PCEP configuration message includes a transport network slice identifier and a slice status request. The method further includes receiving, from the network device, a first PCEP report message including slice status information indicating whether the transport network slice is in an up state, whether a service-level agreement (SLA) of the transport network slice is met, and whether the transport network slice is in a down state. The method further includes reporting, to a performance monitoring system (PMS), the slice status information.

### TECHNICAL FIELD

The present disclosure relates generally to communication systems, and more particularly to methods and apparatuses for using a control plane transport slice identifier for end-to-end 5G network slicing mapping.

### BACKGROUND

Related communication systems, such as wireless communication systems (e.g., 4G, Long Term Evolution (LTE), 5G) may be deployed to provide various telecommunication services such as telephony, video, data, messaging, and broadcasts. In order to meet ever increasing demands for wireless data traffic, network technologies may seek to implement an end-to-end (E2E) system in which all targets are integrated over a network providing access in a wired manner, a wireless manner, or other various schemes. To that end, standardization organizations (e.g., International Telecommunication Union (ITU), Next Generation Mobile Networks (NGMN) Alliance, Third Generation Partnership Project (3GPP), Internet Engineering Task Force (IETF)) may define and/or design system and/or network architectures to implement network technologies that may feature high performance, low latency, and high availability.

One such network technology may involve the adoption of network slicing for radio access networks (RANs) and core networks (CNs) that are interconnected to each other via transport networks (TNs). Under network slicing, network resources and network functions may be bundled into network slices depending on individual services, service level agreements (SLAs), and/or network path routing to be provided by each network slice. That is, a network slice over a communication network may provide customized network services by combining control plane (CP) and user plane (UP) network functions for network services necessary for a particular service over a CN and a RAN.

Related mechanisms for deploying and implementing network slicing functionality across network domains may rely on the use of different network slice subnet management function (NSSMF) devices for each domain. For example, each of the RAN, CN, and TN domains may each independently implement separate NSSMF devices (e.g., RN-NSSMF, CN-NSSMF, and TN-NSSMF, respectively). As such, each domain (e.g., RAN, CN, and TN) may operate independently without awareness of the other domains. As a result, related network slicing mechanisms may be unable to correlate network usage information (e.g., paths, resources, performance) from each of the domains to present an end-to-end view of a network slice.

Thus, there exists a need for further improvements in 5G network slicing technology. Improvements are presented herein. These improvements may also be applicable to other multi-access technologies and the telecommunication standards that employ these technologies.

### SUMMARY

Methods, apparatuses, and non-transitory computer-readable mediums for monitoring performance of network slices in a transport network are disclosed by the present disclosure.

According to an aspect of the disclosure, a method of monitoring performance of network slices in a transport network by a network controller includes transmitting, to a network device of the transport network using a path computation element communication protocol (PCEP), a PCEP configuration message requesting rendering of a transport network path assigned to a transport network slice. The PCEP configuration message includes a transport network slice identifier corresponding to the transport network slice and a slice status request requesting that the network device provide a status update of the transport network slice. The method further includes receiving, from the network device, a first PCEP report message including first slice status information indicating whether the transport network slice is in an up state, whether a service-level agreement (SLA) of the transport network slice is met, and whether the transport network slice is in a down state. The method further includes reporting, to a performance monitoring system (PMS), the first slice status information of the transport network slice.

According to some embodiments of the disclosure, the PCEP configuration message includes at least one of a PCEP initialization message and a PCEP update message.

According to some embodiments of the disclosure, the method further includes receiving, from a network slice management controller, a network slice creation request including a source address, a destination address, and the SLA. The method further includes creating, based on the network slice creation request, the transport network slice. The method further includes computing the transport network path according to the source address, the destination address, and the SLA. The method further includes assigning the transport network path to the transport network slice.

According to some embodiments of the disclosure, the receiving of the network slice creation request further includes receiving the network slice creation request via a representational state transfer application programming interface (REST-API).

According to some embodiments of the disclosure, the method further includes updating, based on one or more network topology changes, the transport network path to obtain an updated transport network path. The method further includes transmitting, to the network device, a PCEP update message including the updated transport network path and another slice status request. The method further includes receiving, from the network device, a second PCEP report message including second slice status information indicating whether the transport network slice is in the up state, whether the SLA of the transport network slice is met, and whether the transport network slice is in the down state. The method further includes reporting, to the PMS, the second slice status information of the transport network slice.

According to some embodiments of the disclosure, the method further includes receiving, via at least one border gateway protocol link state (BGP-LS) message, information indicating the one or more network topology changes.

According to some embodiments of the disclosure, the first slice status information has been determined according to one or more segment routing performance monitoring (SR-PM) messages received from one or more other network devices rendering the transport network path.

According to some embodiments of the disclosure, the network device of the transport network is an ingress provider edge (PE) device of the transport network path.

According to some embodiments of the disclosure, the method further includes reporting, to a network slice management controller, the first slice status information of the transport network slice.

According to some embodiments of the disclosure, the reporting, to the PMS, of the first slice status information of the transport network slice includes reporting the first slice status information to the PMS via a first REST-API. According to some embodiments of the disclosure, the reporting, to the network slice management controller, of the first slice status information includes reporting the first slice status information to the network slice management controller via a second REST-API.

According to another aspect of the disclosure, an apparatus, for monitoring performance of network slices in a transport network, includes a memory storage storing computer-executable instructions and a processor communicatively coupled to the memory storage. The processor is configured to execute the computer-executable instructions and cause the apparatus to transmit, to a network device of the transport network using a PCEP, a PCEP configuration message requesting rendering of a transport network path assigned to a transport network slice. The PCEP configuration message includes a transport network slice identifier corresponding to the transport network slice and a slice status request requesting that the network device provide a status update of the transport network slice. The computer-executable instructions further cause the apparatus to receive, from the network device, a first PCEP report message including first slice status information indicating whether the transport network slice is in an up state, whether a SLA of the transport network slice is met, and whether the transport network slice is in a down state. The computer-executable instructions further cause the apparatus to report, to a PMS, the first slice status information of the transport network slice.

According to another aspect of the disclosure, a non-transitory computer-readable storage medium has recorded thereon a program for monitoring performance of network slices in a transport network by an apparatus. The program includes operations to transmit, to a network device of the transport network using a PCEP, a PCEP configuration message requesting rendering of a transport network path assigned to a transport network slice. The PCEP configuration message includes a transport network slice identifier corresponding to the transport network slice and a slice status request requesting that the network device provide a status update of the transport network slice. The program includes further operations to receive, from the network device, a first PCEP report message including first slice status information indicating whether the transport network slice is in an up state, whether a SLA of the transport network slice is met, and whether the transport network slice is in a down state. The program includes further operations to report, to a PMS, the first slice status information of the transport network slice.

According to another aspect of the disclosure, a method of monitoring performance of network slices in a transport network by a network device includes receiving, from a network controller using a PCEP, a PCEP configuration message requesting rendering of a transport network path assigned to a transport network slice. The PCEP configuration message includes a transport network slice identifier corresponding to the transport network slice and a slice status request requesting that the network device provide a status update of the transport network slice. The method further includes rendering, using one or more other network devices of the transport network, the transport network path. The method further includes obtaining, from the one or more other network devices, first slice status information indicating whether the transport network slice is in an up state, whether a SLA of the transport network slice is met, and whether the transport network slice is in a down state. The method further includes transmitting, to the network controller, a first PCEP report message including the first slice status information.

According to some embodiments of the disclosure, the obtaining of the first slice status information includes transmitting, to the one or more other network devices, one or more SR-PM messages. The obtaining further includes receiving, from the one or more other network devices, responses to the one or more SR-PM messages includes the first slice status information.

According to some embodiments of the disclosure, the method further includes receiving, from the network device, a PCEP update message including an updated transport network path and another slice status request. The method further includes reconfiguring, based on the updated transport network path, at least one network device of the one or more other network devices. The method further includes obtaining, from the one or more other network devices, second slice status information indicating whether the transport network slice is in the up state, whether the SLA of the transport network slice is met, and whether the transport network slice is in the down state. The method further includes transmitting, to the network controller, a second PCEP report message including the second slice status information.

According to some embodiments of the disclosure, the network device of the transport network is an ingress provider edge (PE) device of the transport network path.

According to another aspect of the disclosure, an apparatus, for monitoring performance of network slices in a transport network, includes a memory storage storing computer-executable instructions and a processor communicatively coupled to the memory storage. The processor is configured to execute the computer-executable instructions and cause the apparatus to receive, from a network controller using a PCEP, a PCEP configuration message requesting rendering of a transport network path assigned to a transport network slice. The PCEP configuration message includes a transport network slice identifier corresponding to the transport network slice and a slice status request requesting that the network device provide a status update of the transport network slice. The computer-executable instructions further cause the apparatus to render, using one or more other network devices of the transport network, the transport network path. The computer-executable instructions further cause the apparatus to obtain, from the one or more other network devices, first slice status information indicating whether the transport network slice is in an up state, whether a SLA of the transport network slice is met, and whether the transport network slice is in a down state. The computer-executable instructions further cause the apparatus to transmit, to the network controller, a first PCEP report message including the first slice status information.

According to another aspect of the disclosure, a non-transitory computer-readable storage medium has recorded thereon a program for monitoring performance of network slices in a transport network by an apparatus. The program includes operations to receive, from a network controller using a PCEP, a PCEP configuration message requesting rendering of a transport network path assigned to a transport network slice. The PCEP configuration message includes a transport network slice identifier corresponding to the transport network slice and a slice status request requesting that the network device provide a status update of the transport network slice. The program further includes operations to render, using one or more other network devices of the transport network, the transport network path. The program further includes operations to obtain, from the one or more other network devices, first slice status information indicating whether the transport network slice is in an up state, whether a SLA of the transport network slice is met, and whether the transport network slice is in a down state. The program further includes operations to transmit, to the network controller, a first PCEP report message including the first slice status information.

Additional embodiments will be set forth in the description that follows and, in part, will be apparent from the description, and/or may be learned by practice of the presented embodiments of the disclosure.

### BRIEF DESCRIPTION OF THE DRAWINGS

The above and other aspects, features, and aspects of embodiments of the disclosure will be apparent from the following description taken in conjunction with the accompanying drawings, in which:

FIG. 1 is a diagram of an example device for monitoring performance of network slices in a transport network, in accordance with various embodiments of the present disclosure;

FIG. 2 is a schematic diagram of an example wireless communications system, in accordance with various embodiments of the present disclosure;

FIG. 3 is an example of a high-level network slice architecture for network slice management and configuration in a communications system, in accordance with various embodiments of the present disclosure;

FIG. 4 illustrates an example process for monitoring performance of network slices in a transport network during network slice creation, in accordance with various embodiments of the present disclosure;

FIG. 5 illustrates an example process for monitoring performance of network slices in a transport network during network topology changes, in accordance with various embodiments of the present disclosure;

FIG. 6 illustrates extended path computation element communication protocol (PCEP) messages, in accordance with various embodiments of the present disclosure;

FIG. 7 is a block diagram of an example network controller for monitoring performance of network slices in a transport network, in accordance with various embodiments of the present disclosure;

FIG. 8 is flowchart of an example method of monitoring performance of network slices in a transport network by a network controller, in accordance with various embodiments of the present disclosure.

FIG. 9 is a block diagram of an example network device for monitoring performance of network slices in a transport network, in accordance with various embodiments of the present disclosure;

FIG. 10 is flowchart of an example method of monitoring performance of network slices in a transport network by a network device, in accordance with various embodiments of the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

Network slicing may allow for network resources and network functions to be bundled into network slices depending on individual services, service level agreements (SLAs), and/or network path routing to be provided by each network slice. That is, a network slice over a communication network may provide customized network services by combining control plane (CP) and user plane (UP) network functions for network services necessary for a particular service over a core network (CN) and a radio access network (RAN) that may be interconnected to each other via a transport network (TN).

However, related mechanisms for deploying and implementing network slicing functionality across network domains may rely on the use of different network slice subnet management function (NSSMF) devices for each domain (e.g., RN-NSSMF, CN-NSSMF, and TN-NSSMF). As such, each domain (e.g., RAN, CN, and TN) may operate independently without awareness of the other domains. As a result, related network slicing mechanisms may be unable to correlate network usage information (e.g., paths, resources, performance) from each of the domains to present an end-to-end view of a network slice. For example, the RAN and/or CN domains may be unaware of performance and/or SLA breaches within the TN domain. Such a scenario may be exacerbated if or when multiple RN and/or CN network slices are mapped to a single transport network slice. That is, a single failure within the TN domain may result in failed communications across multiple network slices in the RN and/or CN domains.

Aspects presented herein provide methods and apparatuses for monitoring performance of network slices in a TN such that end-to-end performance of the network slice may be monitored. The performance of network slices may be monitored and/or performance degradations may be identified at an individual network slice and/or flow level within the TN without any interdependency from other domains (e.g., RAN, CN) and/or functionality changes to the other domains. Further, aspects presented herein may improve efficiency and performance of network slicing implementations by allowing for end-to-end monitoring of network slice management and transport network path visualizations.

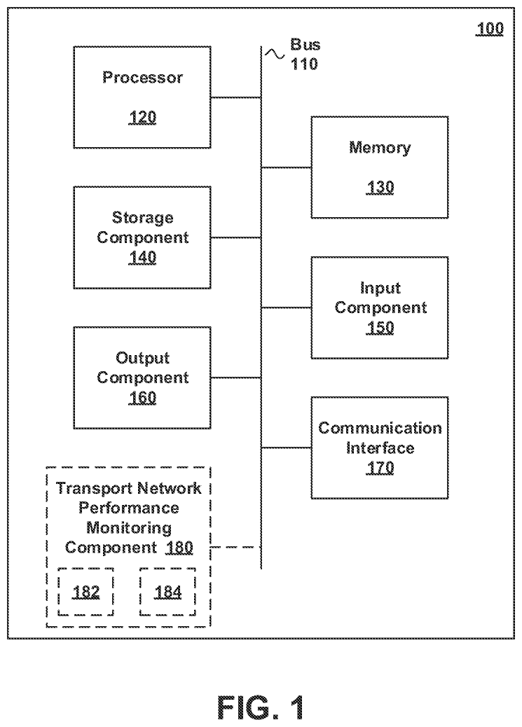

FIG. 1 is diagram of an example device for monitoring performance of network slices in a transport network. Device 100 may correspond to any type of known computer, server, or data processing device. For example, the device 100 may comprise a processor, a personal computer (PC), a printed circuit board (PCB) comprising a computing device, a mini-computer, a mainframe computer, a microcomputer, a telephonic computing device, a wired/wireless computing device (e.g., a smartphone, a personal digital assistant (PDA)), a laptop, a tablet, a smart device, a wearable device, or any other similar functioning device.

In some embodiments, as shown in FIG. 1, the device 100 may include a set of components, such as a processor 120, a memory 130, a storage component 140, an input component 150, an output component 160, a communication interface 170, and a TN performance monitoring component 180. The set of components of the device 100 may be communicatively coupled via a bus 110.

The bus 110 may comprise one or more components that permit communication among the set of components of the device 100. For example, the bus 110 may be a communication bus, a cross-over bar, a network, or the like. Although the bus 110 is depicted as a single line in FIG. 1, the bus 110 may be implemented using multiple (two or more) connections between the set of components of device 100. The disclosure is not limited in this regard.

The device 100 may comprise one or more processors, such as the processor 120. The processor 120 may be implemented in hardware, firmware, and/or a combination of hardware and software. For example, the processor 120 may comprise a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), a general purpose single-chip or multi-chip processor, or other programmable logic device, discrete gate or transistor logic, discrete hardware components, or any combination thereof designed to perform the functions described herein. A general purpose processor may be a microprocessor, or any conventional processor, controller, microcontroller, or state machine. The processor 120 also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The processor 120 may control overall operation of the device 100 and/or of the set of components of device 100 (e.g., the memory 130, the storage component 140, the input component 150, the output component 160, the communication interface 170, the TN performance monitoring component 180).

The device 100 may further comprise the memory 130. In some embodiments, the memory 130 may comprise a random access memory (RAM), a read only memory (ROM), an electrically erasable programmable ROM (EEPROM), a flash memory, a magnetic memory, an optical memory, and/or another type of dynamic or static storage device. The memory 130 may store information and/or instructions for use (e.g., execution) by the processor 120.

The storage component 140 of device 100 may store information and/or computer-readable instructions and/or code related to the operation and use of the device 100. For example, the storage component 140 may include a hard disk (e.g., a magnetic disk, an optical disk, a magneto-optic disk, and/or a solid state disk), a compact disc (CD), a digital versatile disc (DVD), a universal serial bus (USB) flash drive, a Personal Computer Memory Card International Association (PCMCIA) card, a floppy disk, a cartridge, a magnetic tape, and/or another type of non-transitory computer-readable medium, along with a corresponding drive.

The device 100 may further comprise the input component 150. The input component 150 may include one or more components that permit the device 100 to receive information, such as via user input (e.g., a touch screen, a keyboard, a keypad, a mouse, a stylus, a button, a switch, a microphone, a camera, and the like). Alternatively or additionally, the input component 150 may include a sensor for sensing information (e.g., a global positioning system (GPS) component, an accelerometer, a gyroscope, an actuator, and the like).

The output component 160 of device 100 may include one or more components that may provide output information from the device 100 (e.g., a display, a liquid crystal display (LCD), light-emitting diodes (LEDs), organic light emitting diodes (OLEDs), a haptic feedback device, a speaker, and the like).

The device 100 may further comprise the communication interface 170. The communication interface 170 may include a receiver component, a transmitter component, and/or a transceiver component. The communication interface 170 may enable the device 100 to establish connections and/or transfer communications with other devices (e.g., a server, another device). The communications may be effected via a wired connection, a wireless connection, or a combination of wired and wireless connections. The communication interface 170 may permit the device 100 to receive information from another device and/or provide information to another device. In some embodiments, the communication interface 170 may provide for communications with another device via a network, such as a local area network (LAN), a wide area network (WAN), a metropolitan area network (MAN), a private network, an ad hoc network, an intranet, the Internet, a fiber optic-based network, a cellular network (e.g., a fifth generation (5G) network, a long-term evolution (LTE) network, a third generation (3G) network, a code division multiple access (CDMA) network, and the like), a public land mobile network (PLMN), a telephone network (e.g., the Public Switched Telephone Network (PSTN)), or the like, and/or a combination of these or other types of networks. Alternatively or additionally, the communication interface 170 may provide for communications with another device via a device-to-device (D2D) communication link, such as FlashLinQ, WiMedia, Bluetooth, ZigBee, Wi-Fi, LTE, 5G, and the like. In other embodiments, the communication interface 170 may include an Ethernet interface, an optical interface, a coaxial interface, an infrared interface, a radio frequency (RF) interface, or the like.

In some embodiments, the device 100 may comprise the TN performance monitoring component 180 configured to monitor performance of network slices in a transport network. The TN performance monitoring component 180 may include a set of components, such as a TN controller performance monitoring component 182 and/or a TN device performance monitoring component 184. For example, the TN controller performance monitoring component 182 may be configured to transmit a path computation element communication protocol (PCEP) configuration message requesting a status update of the transport network slice, receive a PCEP report message indicating slice status information of the transport network slice, and report the slice status information to a performance monitoring system (PMS). The TN device performance monitoring component 184 may be configured to receive a PCEP configuration message requesting a status update of the transport network slice, render the transport network path, obtain slice status information, and transmit a PCEP report message with the slice status information.

The device 100 may perform one or more processes described herein. The device 100 may perform operations based on the processor 120 executing computer-readable instructions and/or code that may be stored by a non-transitory computer-readable medium, such as the memory 130 and/or the storage component 140. A computer-readable medium may refer to a non-transitory memory device. A memory device may include memory space within a single physical storage device and/or memory space spread across multiple physical storage devices.

Computer-readable instructions and/or code may be read into the memory 130 and/or the storage component 140 from another computer-readable medium or from another device via the communication interface 170. The computer-readable instructions and/or code stored in the memory 130 and/or storage component 140, if or when executed by the processor 120, may cause the device 100 to perform one or more processes described herein.

Alternatively or additionally, hardwired circuitry may be used in place of or in combination with software instructions to perform one or more processes described herein. Thus, embodiments described herein are not limited to any specific combination of hardware circuitry and software.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally or alternatively, a set of (one or more) components shown in FIG. 1 may perform one or more functions described as being performed by another set of components shown in FIG. 1.

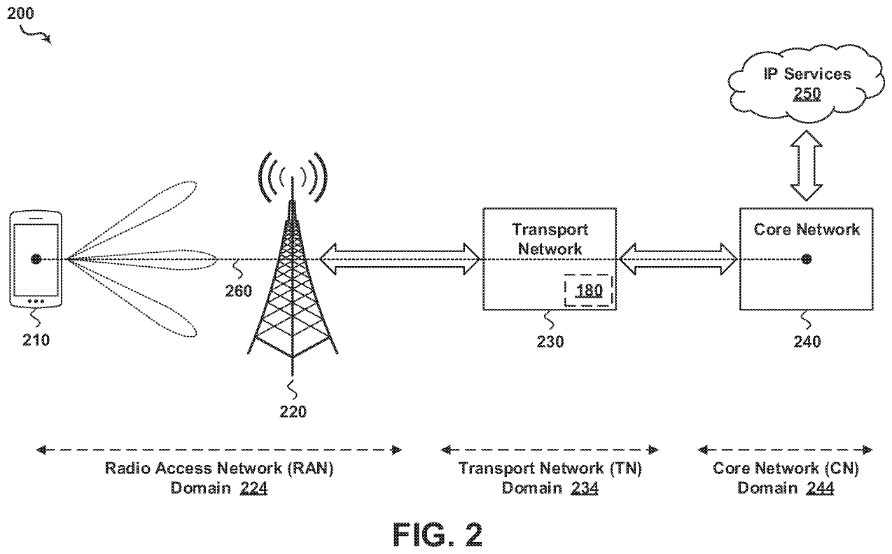

FIG. 2 is a diagram illustrating an example of a wireless communications system, according with various embodiments of the present disclosure. The wireless communications system 200 (which may also be referred to as a wireless wide area network (WWAN)) may include one or more user equipment (UE) 210, one or more base stations 220, at least one transport network 230, and at least one core network 240.

The one or more UEs 210 may access the at least one core network 240 and/or IP services 250 via a connection to the one or more base stations 220 over a RAN domain 224 and through the at least one transport network 230. Examples of UEs 210 may include a cellular phone, a smart phone, a session initiation protocol (SIP) phone, a laptop, a personal digital assistant (PDA), a satellite radio, a global positioning system (GPS), a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similarly functioning device. Some of the one or more UEs 210 may be referred to as Internet-of-Things (IOT) devices (e.g., parking meter, gas pump, toaster, vehicles, heart monitor, etc.). The one or more UEs 210 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile agent, a client, or some other suitable terminology.

The one or more base stations 220 may wirelessly communicate with the one or more UEs 210 over the RAN domain 224. Each base station of the one or more base stations 220 may provide communication coverage to one or more UEs 210 located within a geographic coverage area of that base station 220. In some embodiments, as shown in FIG. 2, the base station 220 may transmit one or more beamformed signals to the one or more UEs 210 in one or more transmit directions. The one or more UEs 210 may receive the beamformed signals from the base station 220 in one or more receive directions. Alternatively or additionally, the one or more UEs 210 may transmit beamformed signals to the base station 220 in one or more transmit directions. The base station 220 may receive the beamformed signals from the one or more UEs 210 in one or more receive directions.

The one or more base stations 220 may include macrocells (e.g., high power cellular base stations) and/or small cells (e.g., low power cellular base stations). The small cells may include femtocells, picocells, and microcells. A base station 220, whether a macrocell or a large cell, may include and/or be referred to as an access point (AP), an evolved (or evolved universal terrestrial radio access network (E-UTRAN)) Node B (eNB), a next-generation Node B (gNB), or another type of base station.

The one or more base stations 220 may be configured to interface (e.g., establish connections, transfer data, and the like) with the at least one core network 240 through at least one transport network 230. In addition to other functions, the one or more base stations 220 may perform one or more of the following functions: transfer of data received from the one or more UEs 210 (e.g., uplink data) to the at least one core network 240 via the at least one transport network 230, transfer of data received from the at least one core network 240 (e.g., downlink data) via the at least one transport network 230 to the one or more UEs 210.

The transport network 230 may transfer data (e.g., uplink data, downlink data) and/or signaling between the RAN domain 224 and the CN domain 244. For example, the transport network 230 may provide one or more backhaul links between the one or more base stations 220 and the at least one core network 240. The backhaul links may be wired or wireless. Alternatively or additionally, the transport network 230 may comprise the TN performance monitoring component 180 of FIG. 1.

The core network 240 may be configured to provide one or more services (e.g., enhanced mobile broadband (eMBB), ultra-reliable low-latency communications (URLLC), and massive machine type communications (mMTC), etc.) to the one or more UEs 210 connected to the RAN domain 224 via the TN domain 234. Alternatively or additionally, the core network 240 may serve as an entry point for the IP services 250. The IP services 250 may include the Internet, an intranet, an IP multimedia subsystem (IMS), a streaming service (e.g., video, audio, gaming, etc.), and/or other IP services.

Continuing to refer to FIG. 2, an end-to-end network slice 260 may provide a required connectivity between the UE 210 and the core network 240 with a specified performance commitment. The end-to-end network slice 260 may refer to a logical network topology connecting a number of endpoints (e.g., UE 210, core network 240) using a set of shared or dedicated network resources (e.g., base station 220, transport network 230) that are used to satisfy a specific performance commitment. The performance commitments that are to be satisfied by the end-to-end network slice 260 may be referred to as service level agreements (SLAs), service level objectives (SLOs), service level expectations (SLEs), and/or service level indicators (SLIs). Examples of these performance commitments may include, but are not limited to, a guaranteed minimum bandwidth (e.g., bandwidth between two end points in a particular direction), a guaranteed maximum latency (e.g., network latency when transmitting between two endpoints), a maximum packet delay variation (PDV) (e.g., a maximum difference in a one-way delay between sequentially transmitted packets in a flow), a maximum permissible packet loss rate (e.g., a ratio of packets dropped to packets transmitted), and a minimum availability ratio (e.g., a ratio of uptime to the sum of uptime and downtime).

The UE 210 may access multiple network slices 260 over one or more base stations 220 (not shown). In some embodiments, each network slice 260 may serve a particular service type with a specified performance commitment.

In some embodiments, each network slice 260 may be identified by a global identifier, such as a single network slice selection assistance information (S-NSSAI). That is, the S-NSSAI may be used by the RAN domain 224, the TN domain 234, and the CN domain 244 to identify the network slice 260.

The S-NSSAI may comprise information regarding a slice and/or service type (SST), which may indicate an expected behavior of the particular network slice in terms of features and/or services. The S-NSSAI may further comprise a slice differentiator (SD), which may allow for further differentiation for selecting a network slice instance from one or more network slice instances that may comply with the indicated SST. Alternatively or additionally, the SST and/or the SD comprised by the S-NSSAI may use standard values and/or may use values specific to a particular network provider (e.g., public land mobile network (PLMN)).

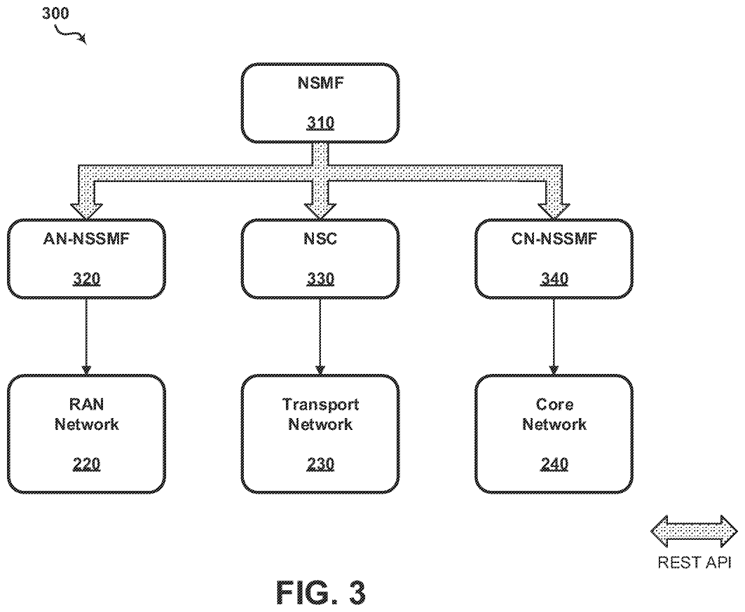

FIG. 3 is an example of a high-level network slice architecture for network slice management and configuration in a communications system, in accordance with various embodiments of the present disclosure. The high-level network slice architecture 300 described in FIG. 3 may be implemented by and/or be included with the wireless communications system 200 described above with reference to FIG. 2, and may include additional features not mentioned above. In some embodiments, at least a portion of the high-level network slice architecture 300 illustrated in FIG. 3 may be performed by the device 100 of FIG. 1, including the TN performance monitoring component 180.

As shown in FIG. 3, a network slice management function (NSMF) 310 may request each domain (e.g., RAN, TN, CN) of the network architecture to create a portion (e.g., subnet) of the network slice 260 in each network domain. That is, the network slice 260 may be implemented by a combination of subnets created within each domain of the network to establish the communication path across the communications system. The NSMF 310 may be configured to generate a S-NSSAI that uniquely identifies the network slice 260. Alternatively or additionally, the NSMF 310 may create one or more service profiles requesting dedicated resources for the network slice 260 in each network domain. The service profiles may be determined according to one or more services to be provided over the network slice 260 and/or the specified performance commitments of the network slice 260.

In some embodiments, the NSMF 310 may use a representational state transfer application programming interface (REST-API) to request each of the domains to create their respective portions of the network slice 260. Alternatively or additionally, the NSMF 310 may transmit and/or send a message comprising the slice creation request to a network element corresponding to each of the network domains. The present disclosure is not limited in this regard.

In some embodiments, the NSMF 310 may send a slice creation request to an access network-network slice subnet management function (AN-NSSMF) 320, such as a RAN path computation element and/or a RAN orchestrator, to create the RAN domain portion of the network slice 260. For example, the slice creation request sent by the NSMF 310 to the AN-NSSMF 320 may comprise the S-NSSAI identifying the network slice 260 and/or the service profile determined for the RAN domain 224.

In response to receiving the slice creation request from the NSMF 310, the AN-NSSMF 320 may allocate one or more resources (e.g., time periods, frequency ranges, bandwidths) of the RAN domain 224 for the network slice 260. That is, the AN-NSSMF 320 may configure one or more base stations 220 of the RAN domain 224 and/or other network elements of the RAN domain 224 to provide a network path between the UE 210 and the transport network 230 according to the performance commitments specified for the network slice 260. Alternatively or additionally, the AN-NSSMF 320 may further allocate the RAN resources according to other performance factors such as, but not limited to, available processing throughput of allocated devices, latency considerations, geographical location of allocated devices, priority of services associated with the network slice 260, and the like.

In some embodiments, the NSMF 310 may send a slice creation request to a transport network-network slice subnet management function (TN-NSSMF) 330, such as a network slice controller (NSC) and/or a TN orchestrator, to create the TN domain portion of the network slice 260. For example, the slice creation request sent by the NSMF 310 to the NSC 330 may comprise the S-NSSAI identifying the network slice 260 and/or the service profile determined for the TN domain 234.

As described in co-pending and commonly assigned International Patent Application No. PCT/US2022/28951, titled “TRANSPORT SLICE IDENTIFIER FOR END-TO-END 5G NETWORK SLICING MAPPING” and filed on May 12, 2022, the disclosure of which is hereby incorporated by reference, the NSC 330 may be configured to generate a transport slice identifier corresponding to the network slice 260 based at least on the S-NSSAI indicated by the slice creation request received from the NSMF 310.

In response to receiving the slice creation request from the NSMF 310, the NSC 330 may compute and/or allocate one or more transport network paths for the network slice 260. For example, the NSC 330 may select transport network paths based at least on a source address indicated by the slice creation request, a destination address indicated by the slice creation request, and/or network path constraints (e.g., service profile, performance commitments) indicated by the slice creation request. Alternatively or additionally, the NSC 330 may configure one or more network elements of the TN network 230 to provide the one or more transport network paths between the RAN domain 224 and the core network 240 according to the performance commitments specified for the network slice 260.

In some embodiments, the NSMF 310 may send a slice creation request to a core network-network slice subnet management function (CN-NSSMF) 340, such as a CN path computation element and/or a CN orchestrator, to create the CN domain portion of the network slice 260. For example, the slice creation request sent by the NSMF 310 to the CN-NSSMF 340 may comprise the S-NSSAI identifying the network slice 260 and/or the service profile determined for the CN domain 244.

In response to receiving the slice creation request from the NSMF 310, the CN-NSSMF 340 may compute and/or allocate one or more core network paths for the network slice 260 to provide a network path between the UE 210 and one or more services indicated by the slice creation request. For example, the CN-NSSMF 340 may select core network paths based at least on a source address indicated by the slice creation request, a destination address indicated by the slice creation request, and/or network path constraints (e.g., service profile, performance commitments) indicated by the slice creation request. Alternatively or additionally, the CN-NSSMF 340 may configure one or more network elements of the CN network 240 to provide the one or more services indicated by the slice creation request to the UE 210, according to the performance commitments specified for the network slice 260.

As described above in reference to FIG. 3, each domain (e.g., RAN, TN, CN) of the network architecture may comprise an independent network slicing management function (e.g., AN-NSSMF 320, NSC 330, CN-NSSMF 340). These management functions may manage their respective portions of the network slice 260 without coordination and/or cooperation among them. As a result, a performance monitoring process may be unable to correlate network usage information (e.g., paths, resources, performance) from each of the domains to present an end-to-end view of a network slice. For example, the RAN domain 224 and/or the CN domain 244 may be unaware of performance and/or SLA breaches within the TN domain 234. Such a scenario may be exacerbated if or when multiple RN and/or CN network slices are mapped to a single transport network slice. That is, a single failure within the TN domain 234 may result in failed communications across multiple network slices in the RAN domain 224 and/or the CN domain 244. Thus, accurate end-to-end network slice performance monitoring and transport path visualizations may not be effected.

Advantageously, the aspects described herein may provide for a TN performance monitoring component 180 that may be configured to monitor performance of network slices in the TN domain 234 such that end-to-end performance of the network slice may be monitored. The TN performance monitoring component 180 may be further configured to report slice status information of the transport slice to a PMS. As a result, the PMS may perform end-to-end monitoring of network slice performance, as well as, visualizations of the transport network paths. Thus, allowing for fault detection and isolation at an individual network slice and/or transport flow level.

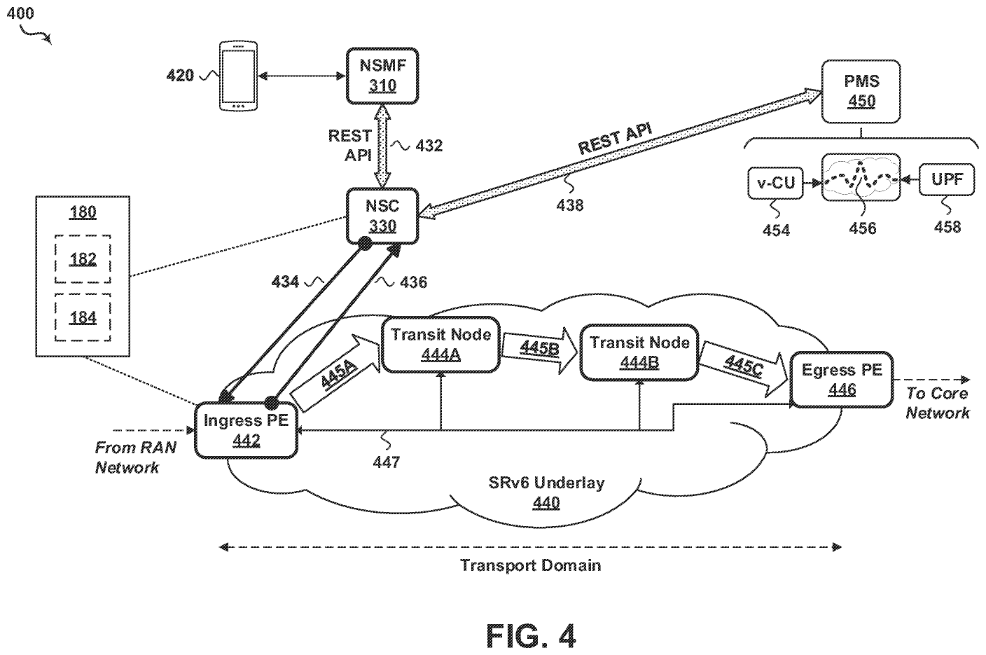

FIG. 4 illustrates an example process for monitoring performance of network slices in a transport network during network slice creation, in accordance with various embodiments of the present disclosure. The process 400 depicted in FIG. 4 may be implemented and/or executed by the NSC 330 described in FIG. 3, including the TN performance monitoring component 180, which may be hosted by the device 100 described in FIG. 1, and may be an element of the wireless communications system 200 described in FIG. 2. The NSC 330 described in FIG. 4 may include and/or may be similar in many respects to the NSC 330 described above with reference to FIG. 3, and may include additional features not mentioned above.

At operation 432, the NSC 330 may receive a slice creation request. In some embodiments, the slice creation request may be obtained from a NSMF 310 via a REST-API. Alternatively or additionally, the NSMF 310 may transmit to the NSC 330 a message comprising the slice creation request. The slice creation request may comprise a global identifier (e.g., S-NSSAI) corresponding to the network slice 260 that is to be created. The slice creation request may further indicate a source address, a destination address, and network path constraints such as performance commitments (e.g., SLA, SLO, SLE, SLI) specified for the network slice 260. The source address may correspond to an ingress transport boundary router (e.g., ingress provider edge (PE) 442) connected to the RAN domain 224. The destination address may correspond to an egress transport boundary router (e.g., egress PE 446) connected to the CN domain 244.

In some embodiments, the NSMF 310 may transmit the slice creation request based on a service request from UE 420 to obtain access to a particular service.

The NSC 330 may create, based on the slice creation request, the transport network slice 260. Alternatively or additionally, the NSC 330 may generate a transport slice identifier (e.g., TN-SliceID) corresponding to the network slice 260 based at least on the S-NSSAI indicated by the slice creation request received from the NSMF 310, as described in co-pending and commonly assigned International Patent Application No. PCT/US2022/28951, titled “TRANSPORT SLICE IDENTIFIER FOR END-TO-END 5G NETWORK SLICING MAPPING” and filed on May 12, 2022, the disclosure of which is hereby incorporated by reference. For example, the NSC 330 may generate the transport slice identifier using the source address, the destination address, and the network path constraints based on a determination of whether the S-NSSAI indicated by the slice creation request is found in a database comprising mappings between S-NSSAI values and transport slice identifier values. In another example, the NSC 330 may generate the transport slice identifier using the source address and the destination address indicated by the slice creation request.

In some embodiments, the NSC 330 may compute a transport network path (e.g., transport network sub-paths 445A, 445B, and 445C, hereinafter “transport network path 445”) according to the source address, the destination address, and the network path constraints (e.g., SLA) indicated by the slice creation request. For example, the NSC 330 may comprise a path computation engine (not shown) configured to provide a mechanism for transport network slice identification (e.g., transport slice identifier) and a dedicated transport network path database for the transport network path 445 computed for the transport network slice. Alternatively or additionally, the path computation engine may be hosted by a device other than the device hosting the NSC 330, and, as such, the NSC 330 may obtain the transport network path 445 by accessing the path computation engine (not shown).

In some embodiments, the network path constraints may indicate desired constraints (e.g., low latency, high bandwidth, high reliability) that are to be met by the computed transport network path 445. The NSC 330 may be configured to assign (associate) the computed transport network path 445 to the transport slice identifier (e.g., TN-SliceID) and the S-NSSAI indicated by the slice creation request.

At operation 434, the NSC 330 may transmit, to a network device of the transport network 440 (e.g., ingress PE 442), a configuration message requesting the rendering (e.g., implementation, deployment) of the computed transport network path 445 by the transport network 440. That is, the configuration message may cause the transport network 440 to render the computed transport network path 445 such that the network slice 260 may be implemented according to the slice creation request. In some embodiments, the NSC 330 may transmit the configuration message to another network device of the transport network 440, such as transit node 444A and/or transit node 444B, for example. In some embodiments, the transport network 440 may comprise a SRv6 underlay to provide configurable connectivity and implement the transport network path 445.

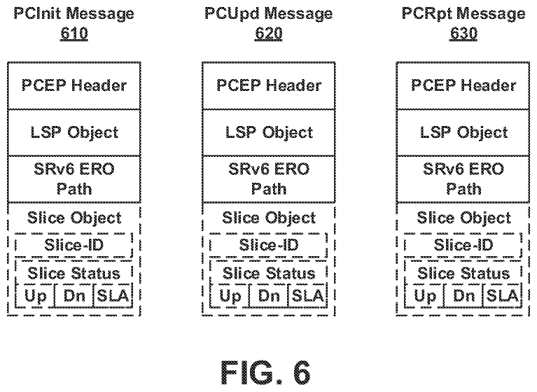

In some embodiments, the NSC 330 may transmit the configuration message using PCEP. That is, the configuration message may be a PCEP configuration message, such as, but not limited to, a PCEP initialization message (e.g., PCInit message 610 of FIG. 6) and/or a PCEP update message (e.g., PCUpd message 620 of FIG. 6). Alternatively or additionally, the PCEP configuration message may be extended to include a slice object, as shown in FIG. 6. For example, a related PCInit message may typically include a PCEP header, a label switched path (LSP) object, and a segment routing IPV6 (SRv6) explicit route object (ERO) path. In some embodiments, the SRv6 ERO path of the PCInit message may comprise the computed transport network path 445 to be rendered by the transport network 450. Alternatively or additionally, the SRv6 ERO path of the PCInit message may comprise the TN-SliceID that identifies the transport network path 445 indicated by the the SRv6 ERO path field.

The PCInit message 610 may be extended, as shown in FIG. 6, to further include the slice object. The slice object may include a slice-ID field comprising the transport network slice identifier (e.g., TN-SliceID) and a slice status field. The slice status field may indicate whether the transport network slice is in an up state, whether the SLA of the transport network slice is met, and whether the transport network slice is in a down state. Alternatively or additionally, the slice status field may indicate a request for the network device to provide a status update of the transport network slice.

In some embodiments, the slice status field may comprise a first sub-field (e.g., a first bit) indicating whether the transport network slice is in the up state. For example, the first sub-field may be set to a particular value (e.g., “1”) to indicate that the transport network slice is in the up state. In some embodiments, the transport network may be determined to be in the up state based on a packet drop rate of the transport network. That is, the transport network may be determined to be in the up state if or when the packet drop rate of the transport network is less than or equal to a first packet drop rate threshold (e.g., 10%).

In some embodiments, the slice status field may comprise a second sub-field (e.g., a second bit) indicating whether the SLA of the transport network slice is met. For example, the second sub-field may be set to a particular value (e.g., “1”) to indicate that the SLA of the transport network slice is met and/or may be set to another value (e.g., “0”) to indicate that the SLA of the transport network slice is breached (e.g., not met). The SLA of the transport network slice may be determined to be met if or when performance criteria specified by the SLA has been met. For example, if or when the SLA requires that latency is not to exceed a particular threshold, determining whether the SLA of the transport network slice is being met may be based at least on whether latency values of the transport network slice exceed the particular threshold. Alternatively or additionally, if or when the SLA requires a maximum PDV, determining whether the SLA of the transport network slice is being met may be based at least on whether PDV values of the transport network slice exceed the specified maximum PDV. In another example, if or when the SLA requires that PDV values remain stable (e.g., variation is constant), determining whether the SLA of the transport network slice is being met may be based at least on whether the PDV values of the transport network slice remain stable. In another example, if or when the SLA requires a maximum packet drop rate (e.g., 0% of packets are dropped), determining whether the SLA of the transport network slice is being met may be based at least on whether the packet drop rate of the transport network slice is less than or equal to the specified maximum packet drop rate.

In some embodiments, the slice status field may comprise a third sub-field (e.g., a third bit) indicating whether the transport network slice is in the down state. For example, the third sub-field may be set to a particular value (e.g., “1”) to indicate that the transport network slice is in the down state. In some embodiments, the transport network may be determined to be in the down state based on the packet drop rate of the transport network. That is, the transport network may be determined to be in the down state if or when the packet drop rate of the transport network is greater than or equal to a second packet drop rate threshold (e.g., 100%).

That is, the slice status field may indicate that the transport network slice is up and that the SLA is met, if or when the first (“up”) sub-field is set to “1”, the second (“SLA”) sub-field is set to “1”, and the third (“down”) sub-field is set to “0”. Alternatively or additionally, the slice status field may indicate that the transport network slice is up and that the SLA is breached (e.g., not met), if or when the first (“up”) sub-field is set to “1”, the second (“SLA”) sub-field is set to “0”, and the third (“down”) sub-field is set to “0”. In another example, the slice status field may indicate that the transport network slice is down, if or when the first (“up”) sub-field is set to “0”, the second (“SLA”) sub-field is set to “0”, and the third (“down”) sub-field is set to “1”.

Alternatively or additionally, the slice status field may indicate whether a status update is being requested. In some embodiments, the slice status field may indicate whether the status update is being requested based on a particular combination of values set for the first, second, and third sub-fields (e.g., an empty status value). For example, the first, second, and third sub-fields may be set to a same value (e.g., “0”) to indicate that the status update is being requested. In other optional or additional embodiments, the slice status field may comprise a fourth sub-field (e.g., a fourth bit, not shown) to indicate whether the status update is being requested.

Continuing to refer to FIG. 6, the PCEP update message (e.g., PCUpd message 620) and the PCEP report message (e.g., PCRpt message 630) may be extended in a similar manner as described above in reference to the PCInit message 610.

Returning to FIG. 4, at operation 436, the ingress PE 442 may render the computed transport network path 445 indicated by the configuration message received from the NSC 330. For example, in response to the configuration message, the ingress PE 442 may establish a connection with the RAN network 224, may configure a first transport network sub-path 445A between the ingress PE 442 and the transit node 444A, may configure a second transport network sub-path 445B between the first transit node 444A and the second transit node 444B, may configure a third transport network sub-path 445C between the second transit node 444B and the egress PE 446, and may configured the egress PE 446 to establish a connection with the core network 240. That is, the ingress PE 442 may configure the transport network 440 to implement the computed transport network path 445.

It may be understood that the example transport network path 445 illustrated in FIG. 4 is only one example of a near infinite number of possible transport network paths and that the ingress PE 442 may configure the transport network 440 with any other possible transport network path without deviating from the scope of the present disclosure.

The ingress PE 442 may be further configured to obtain slice status information indicating whether the transport network slice is in the up state, whether the SLA of the transport network slice is met, and whether the transport network slice is in the down state. In some embodiments, the ingress PE 442 may transmit, to one or more network devices of the transport network 440 implementing the transport network path 445, one or more messages requesting status information related to the transport network slice. For example, the ingress PE 442 may transmit at least one message to each of the transit node 444A, the transit node 444B, and the egress PE 446 requesting the status information related to the transport network slice. The status information may indicate whether each portion of the transport network path 445 (e.g., transport network sub-paths 445A-C), as well as, the connections to the RAN network 224 and to the core network 240 are in the up state, the down state, or whether the path restrictions are being met.

In some embodiments, the ingress PE 442 may transmit one or more segment routing performance monitoring (SR-PM) messages 447 to the one or more network devices of the transport network 440. The SR-PM messages may be configured to request status information related to the transport network slice. In response, the ingress PE 442 may receive, from the one or more other network devices, responses to the one or more SR-PM messages comprising the first slice status information.

In some embodiments, the ingress PE 442 may obtain performance information from the one or more network devices of the transport network 440, such as, but not limited to, latency, packet drop rates, and PDV (e.g., jitter). The ingress PE 442 may be configured to determine whether the SLA of the transport network slice is being met based on the performance information obtained from the one or more network devices of the transport network 440. For example, if or when the SLA requires that latency is not to exceed a particular threshold, the ingress PE 442 may determine whether the SLA of the transport network slice is being met based at least on whether the obtained latency values exceed the particular threshold. Alternatively or additionally, if or when the SLA requires a maximum PDV, the ingress PE 442 may determine whether the SLA of the transport network slice is being met based at least on whether the obtained PDV values exceed the specified maximum PDV. In another example, if or when the SLA requires that PDV values remain stable (e.g., variation is constant), the ingress PE 442 may determine whether the SLA of the transport network slice is being met based at least on whether the obtained PDV values remain stable. In another example, if or when the SLA requires a maximum packet drop rate (e.g., 0% of packets are dropped), the ingress PE 442 may determine whether the SLA of the transport network slice is being met based at least on whether the packet drop rate is less than or equal to the specified maximum packet drop rate.

In some embodiments, the ingress PE 442 may determine whether the transport network slice is in the up state or the down state based on the packet drop rate of the transport network slice. For example, the ingress PE 442 may determine that the transport network slice is in the up state if or when the packet drop rate of the transport network slice is less than or equal to a first packet drop rate threshold (e.g., 10%). Alternatively or additionally, the ingress PE 442 may determine that the transport network slice is in the down state if or when the packet drop rate of the transport network slice is greater than or equal to a second packet drop rate threshold (e.g., 100%).

At operation 436, the ingress PE 442 may transmit, to the NSC 330, a report message comprising the slice status information indicating whether the transport network slice is in the up state, whether the SLA of the transport network slice is met, and whether the transport network slice is in the down state. For example, the ingress PE 442 may transmit, using PCEP, a PCRpt message 630, as shown in FIG. 6, that has been extended to include the slice object identifying the transport network slice (e.g., TN-SliceID) and indicating the slice status of the transport network slice.

That is, at operation 436, the NSC 330 may receive, from the ingress PE 442 (and/or another network device of the transport network 440), an extended PCEP report message (e.g., PCRpt message 630) comprising slice status information indicating whether the transport network slice is in the up state, whether the SLA of the transport network slice is met, and whether the transport network slice is in the down state.

At operation 438, the NSC 330 may report the slice status information to a PMS 450. In some embodiments, the slice status information may be published and/or provided to the PMS 450 via a REST-API. Alternatively or additionally, the NSC 330 may report the slice status information to the NSMF 310. In some embodiments, the slice status information may be published and/or provided to the NSMF 310 via a REST-API. Alternatively or additionally, the NSC 330 may report the slice status information to the RAN network 220 and/or the core network 240. In some embodiments, the slice status information may be published and/or provided to the RAN network 220 and/or the core network 240 via a REST-API.

In some embodiments, the PMS 450 may be deployed in an operator network and may be configured to correlate network usage information (e.g., paths, resources, performance) from each of the network slice architecture domains (e.g., RAN, TN, CN) to present an end-to-end view of the network slice 260. Alternatively or additionally, the PMS 450 may further use the information provided by each of the network slice architecture domains to provide an end-to-end network slice path visualization. In some embodiments, the PMS 450 may utilize a BGP-LS protocol to obtain information (e.g., configuration, status, performance) of the transport domain 234 for creating the path visualizations.

For example, as shown in FIG. 4, based on an example of mapping information, the PMS 450 may present that a virtual central unit (v-CU) 454 in the RAN domain 224 that is communicatively connected (e.g., coupled) to a user plane function (UPF) 458 via a transport path 456. Alternatively or additionally, the PMS 450 may present performance and/or status information of the transport network slice 456 based on the slice status information reported to the NSC 330.

It may be understood that the example network slice configuration presented by the PMS 450 as illustrated in FIG. 4 is only one example of a near infinite number of possible network slice configurations and that the PMS 450 may present any other possible network slice configuration without deviating from the scope of the present disclosure.

The number and arrangement of components shown in FIG. 4 are provided as an example. In practice, there may be additional components, fewer components, different components, or differently arranged components than those shown in FIG. 4. Furthermore, two or more components shown in FIG. 4 may be implemented within a single component, or a single component shown in FIG. 4 may be implemented as multiple, distributed components. Additionally or alternatively, a set of (one or more) components shown in FIG. 4 may perform one or more functions described as being performed by another set of components shown in FIGS. 1-4.

It may be understood that the specific order of the operations, the quantity of operations, and arrangement of operations in the process 400 described in FIG. 4 is an illustration of one example approach. Based upon design preferences, it may be understood that the specific order, quantity, and/or arrangement of operations in the process 400 may be rearranged. Further, some operations may be added, combined, or omitted.

Advantageously, the aspects described herein may provide for a TN performance monitoring component 180 that may be configured to monitor performance of network slices in the TN domain 234 such that end-to-end performance of the network slice may be monitored. The TN performance monitoring component 180 may be further configured to report slice status information of the transport slice to a PMS 450 and to a NSMF 310. As a result, the PMS 450 may perform end-to-end monitoring of network slice performance, as well as, visualizations of the transport network paths. Thus, allowing for fault detection and isolation at an individual network slice and/or transport flow level.

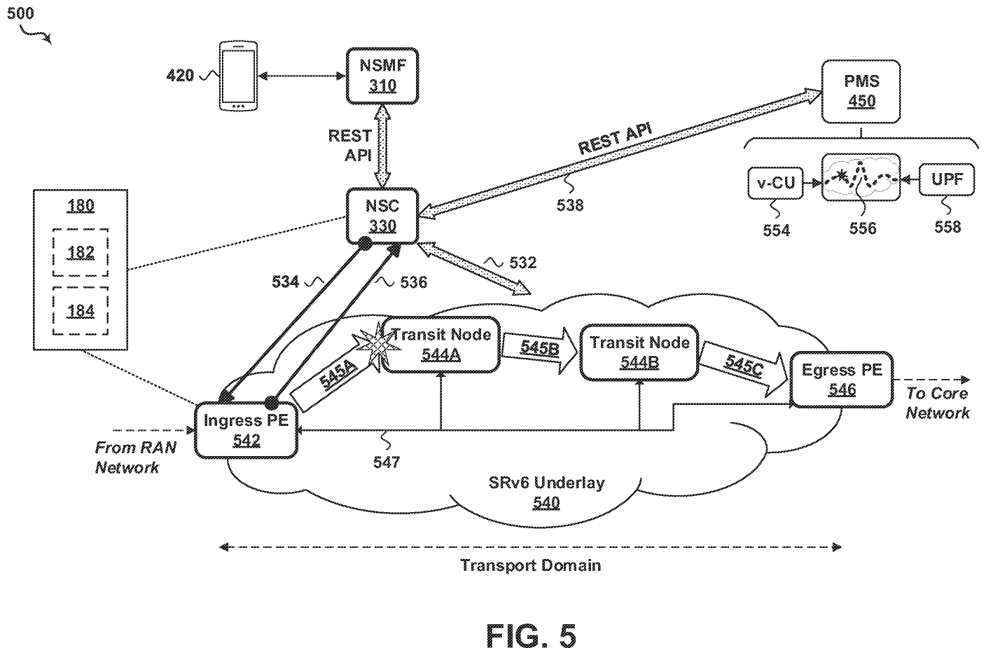

FIG. 5 illustrates an example process for monitoring performance of network slices in a transport network during network topology changes, in accordance with various embodiments of the present disclosure. The process 500 depicted in FIG. 5 may be implemented and/or executed by the NSC 330 described in FIGS. 3 and 4, including the TN performance monitoring component 180, which may be hosted by the device 100 described in FIG. 1, and may be an element of the wireless communications system 200 described in FIG. 2. The NSC 330 described in FIG. 5 may include and/or may be similar in many respects to the NSC 330 described above with reference to FIGS. 3 and 4, and may include additional features not mentioned above.

At operation 532, the NSC 330 may receive network topology changes from the transport network 540. For example, the NSC 330 may receive, via at least one border gateway protocol link state (BGP-LS) message, information indicating one or more network topology changes of the transport network 540. That is, network topology changes to the transport network 540 may be propagated to the NSC 330 via BGP-LS messages.

The NSC 330 may identify whether the network topology changes affect and/or impact any of the transport network slices maintained by the NSC 330. For example, the NSC 330 may search a transport slice path mapping database (not shown) indicating a relationship (e.g., correspondence) between the transport network slice identifier (e.g., TN-SliceID) and a network path identifier of the transport network path (e.g., network path 445, network path 545) assigned to the transport network slice, as described in co-pending and commonly assigned International Patent Application No. PCT/US2022/28951, titled “TRANSPORT SLICE IDENTIFIER FOR END-TO-END 5G NETWORK SLICING MAPPING” and filed on May 12, 2022, the disclosure of which is hereby incorporated by reference. For example, the network path identifier may correspond to an entry in a SRv6 transport element database (SRv6TE-DB) of the transport network 540 that defines the configuration of the transport network path assigned to the transport network slice.

In some embodiments, the NSC 330 may be configured to recompute (e.g., update) the transport network path 545 based on the network topology changes.

At operation 534, the NSC 330 may transmit, to a network device of the transport network 540 (e.g., ingress PE 542), an update message requesting the updating (e.g., implementation, deployment) of the computed transport network path 545 by the transport network 540. That is, the update message may cause the transport network 540 to update the computed transport network path 545 based on the network topology changes. In some embodiments, the NSC 330 may transmit the update message to another network device of the transport network 540, such as transit node 544A and/or transit node 544B, for example.

In some embodiments, the NSC 330 may transmit the update message using PCEP. That is, the update message may be a PCEP update message, such as, but not limited to, the extended PCEP update message (e.g., PCUpd message 620 of FIG. 6). Alternatively or additionally, the PCEP update message may be extended to include a slice object, as shown in FIG. 6, and as described above in reference to FIG. 4. In some embodiments, the SRv6 ERO path of the PCUpd message may comprise the updated transport network path 545 to be rendered by the transport network 540.

At operation 536, the ingress PE 542 may render (e.g., reconfigure) the updated transport network path 545 indicated by the update message received from the NSC 330. For example, in response to the update message, the ingress PE 542 may reconfigure the connection with the RAN network 224, may reconfigure the first transport network sub-path 545A between the ingress PE 542 and the transit node 544A, may reconfigure the second transport network sub-path 545B between the first transit node 544A and the second transit node 544B, may reconfigure the third transport network sub-path 545C between the second transit node 544B and the egress PE 546, or may reconfigure the connection between the egress PE 546 and the core network 240. That is, the ingress PE 542 may reconfigure the transport network 540 to implement the updated transport network path 545.

It may be understood that the example transport network path 545 illustrated in FIG. 5 is only one example of a near infinite number of possible transport network paths and that the ingress PE 542 may configure the transport network 540 with any other possible transport network path without deviating from the scope of the present disclosure.

The ingress PE 542 may be further configured to obtain slice status information indicating whether the reconfigured transport network slice is in the up state, whether the SLA of the transport network slice is met, and whether the transport network slice is in the down state. In some embodiments, the ingress PE 542 may transmit, to one or more network devices of the transport network 540 implementing the transport network path 545, one or more messages requesting status information related to the transport network slice. For example, the ingress PE 542 may transmit at least one message to each of the transit node 544A, the transit node 544B, and the egress PE 546 requesting the status information related to the updated transport network slice. The status information may indicate whether each portion of the updated transport network path 545 (e.g., transport network sub-paths 545A-C), as well as, the connections to the RAN network 224 and to the core network 240 are in the up state, the down state, or whether the path restrictions are being met.

In some embodiments, the ingress PE 542 may transmit one or more segment routing performance monitoring (SR-PM) messages 547 to the one or more network devices of the transport network 540. The SR-PM messages may be configured to request status information related to the transport network slice. In response, the ingress PE 542 may receive, from the one or more other network devices, responses to the one or more SR-PM messages comprising the first slice status information.

In some embodiments, the ingress PE 542 may obtain performance information from the one or more network devices of the transport network 540, such as, but not limited to, latency, packet drop rates, and packet delay variation. The ingress PE 542 may be configured to determine whether the SLA of the transport network slice based on the performance information obtained from the one or more network devices of the transport network 440. For example, if or when the SLA requires that latency is not to exceed a particular threshold, the ingress PE 542 may determine whether the obtained latency values exceed the particular threshold.

By way of example, as shown in FIG. 5, the first transport network sub-path 545A may exhibit a breach. That is, the first transport network sub-path 545A may be down or may not meet the SLA for the transport network slice. As such, the ingress PE 542 may obtain slice status information indicating that the transport network slice is down or that the SLA for the transport network slice is not met.

At operation 536, the ingress PE 542 may transmit, to the NSC 330, a report message comprising the slice status information indicating that the SLA of the transport network slice is not met, or that the transport network slice is in the down state. For example, the ingress PE 542 may transmit, using PCEP, a PCRpt message 630, as shown in FIG. 6, that has been extended to include the slice object identifying the transport network slice (e.g., TN-SliceID) and indicating the slice status of the transport network slice.

That is, at operation 536, the NSC 330 may receive, from the ingress PE 542 (and/or another network device of the transport network 540), an extended PCEP report message (e.g., PCRpt message 630) comprising slice status information indicating that the SLA of the transport network slice is not met, or that the transport network slice is in the down state.

At operation 538, the NSC 330 may report the updated slice status information to a PMS 450. In some embodiments, the slice status information may be published and/or provided to the PMS 450 via a REST-API. Alternatively or additionally, the NSC 330 may report the slice status information to the NSMF 310. In some embodiments, the slice status information may be published and/or provided to the NSMF 310 via a REST-API.

In some embodiments, the PMS 450 may be configured to correlate network usage information (e.g., paths, resources, performance) from each of the network slice architecture domains (e.g., RAN, TN, CN) to present an end-to-end view of the network slice 260. Alternatively or additionally, the PMS 450 may further use the information provided by each of the network slice architecture domains to provide an end-to-end network slice path visualization. In some embodiments, the PMS 450 may utilize a BGP-LS protocol to obtain information (e.g., configuration, status, performance) of the transport domain 234 for creating the path visualizations.

For example, as shown in FIG. 5, based on an example of mapping information, the PMS 450 may present that a virtual central unit (v-CU) 554 in the RAN domain 224 that is communicatively connected (e.g., coupled) to a user plane function (UPF) 558 via a transport path 556. Alternatively or additionally, the PMS 450 may present performance and/or status information of the transport network slice 556 based on the slice status information reported to the NSC 330. For example, the PMS 450 may present that the transport path 556 does not meet the SLA constraints or that the path is down, based on the slice status information provided by the NSC 330.

It may be understood that the example network slice configuration presented by the PMS 450 as illustrated in FIG. 5 is only one example of a near infinite number of possible network slice configurations and that the PMS 450 may present any other possible network slice configuration without deviating from the scope of the present disclosure.

The number and arrangement of components shown in FIG. 5 are provided as an example. In practice, there may be additional components, fewer components, different components, or differently arranged components than those shown in FIG. 5. Furthermore, two or more components shown in FIG. 5 may be implemented within a single component, or a single component shown in FIG. 5 may be implemented as multiple, distributed components. Additionally or alternatively, a set of (one or more) components shown in FIG. 5 may perform one or more functions described as being performed by another set of components shown in FIGS. 1-5.

It may be understood that the specific order of the operations, the quantity of operations, and arrangement of operations in the process 500 described in FIG. 5 is an illustration of one example approach. Based upon design preferences, it may be understood that the specific order, quantity, and/or arrangement of operations in the process 500 may be rearranged. Further, some operations may be added, combined, or omitted.

Advantageously, the aspects described herein may provide for a TN performance monitoring component 180 that may be configured to monitor performance of network slices in the TN domain 234 such that end-to-end performance of the network slice may be monitored during network topology changes. The TN performance monitoring component 180 may be further configured to report slice status information of the transport slice to a PMS 450 and to a NSMF 310. As a result, the PMS 450 may perform end-to-end monitoring of network slice performance, as well as, visualizations of the transport network paths. Thus, allowing for fault detection and isolation at an individual network slice and/or transport flow level.

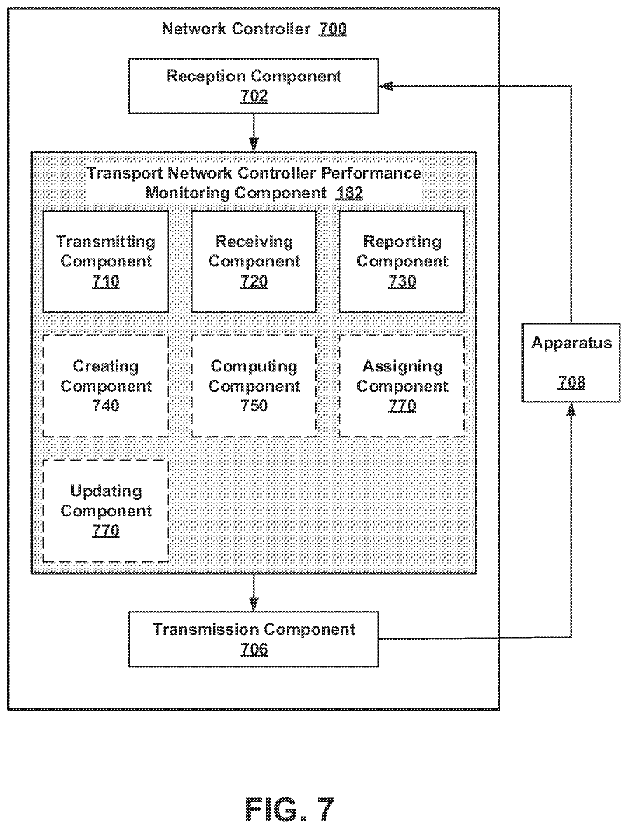

FIG. 7 is a block diagram of an example network controller 700 for monitoring performance of network slices in a transport network. The apparatus 700 may be a computing device (e.g., device 100 of FIG. 1, NSC 330 of FIGS. 3-5) or a computing device may include the apparatus 700. In some embodiments, the apparatus 700 may include a reception component 702 configured to receive communications (e.g., wired, wireless) from another apparatus (e.g., apparatus 708), a TN controller performance monitoring component 182 configured to monitor performance of network slices in a transport network, and a transmission component 706 configured to transmit communications (e.g., wired, wireless) to another apparatus (e.g., apparatus 708). The components of the apparatus 700 may be in communication with one another (e.g., via one or more buses or electrical connections). As shown in FIG. 7, the apparatus 700 may be in communication with another apparatus 708 (such as the PMS 450 of FIGS. 4 and 5, the ingress PE 442, the ingress PE 542, a database, a server, or another computing device) using the reception component 702 and/or the transmission component 706.

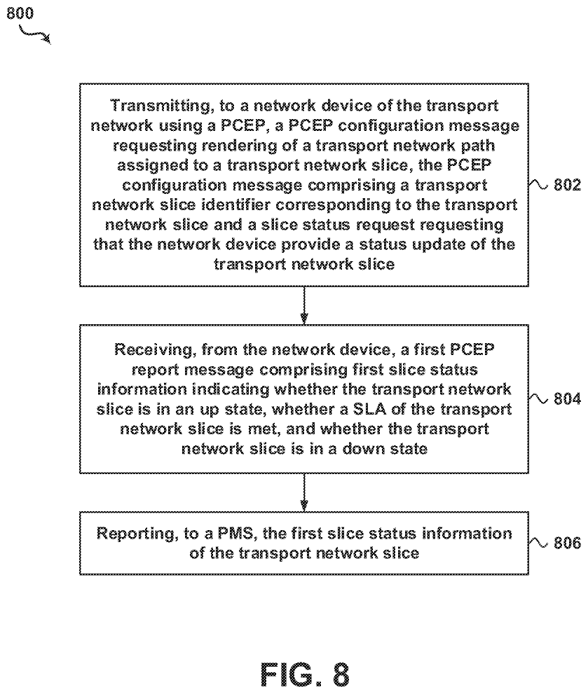

In some embodiments, the apparatus 700 may be configured to perform one or more operations described herein in connection with FIGS. 1-6. Alternatively or additionally, the apparatus 700 may be configured to perform one or more processes described herein, such as method 800 of FIG. 8. In some embodiments, the apparatus 700 may include one or more components of the device 100 described above in connection with FIGS. 1-6.

The reception component 702 may receive communications, such as control information, data communications, or a combination thereof, from the apparatus 708 (e.g., the PMS 450 of FIGS. 4 and 5, the ingress PE 442, the ingress PE 542). The reception component 702 may provide received communications to one or more other components of the apparatus 700, such as the TN controller performance monitoring component 182. In some aspects, the reception component 702 may perform signal processing on the received communications, and may provide the processed signals to the one or more other components. In some embodiments, the reception component 702 may include one or more antennas, a receive processor, a controller/processor, a memory, or a combination thereof, of the device 100 described above in reference to FIG. 1.

The transmission component 706 may transmit communications, such as control information, data communications, or a combination thereof, to the apparatus 708 (e.g., the PMS 450 of FIGS. 4 and 5, the ingress PE 442, the ingress PE 542). In some embodiments, the TN controller performance monitoring component 182 may generate communications and may transmit the generated communications to the transmission component 706 for transmission to the apparatus 708. In some embodiments, the transmission component 706 may perform signal processing on the generated communications, and may transmit the processed signals to the apparatus 708. In other embodiments, the transmission component 706 may include one or more antennas, a transmit processor, a controller/processor, a memory, or a combination thereof, of the device 100 described above in reference to FIG. 1. In some embodiments, the transmission component 706 may be co-located with the reception component 702 such as in a transceiver and/or a transceiver component.

The TN controller performance monitoring component 182 may be configured to monitor performance of network slices in a transport network. In some embodiments, the TN controller performance monitoring component 182 may include a set of components, such as a transmitting component 710 configured to transmit a PCEP configuration message requesting a status update of the transport network slice, a receiving component 720 configured to receive a PCEP report message indicating slice status information of the transport network slice, and a reporting component 630 configured to report the slice status information to a PMS.

Alternatively or additionally, the TN controller performance monitoring component 182 may further include a creating component 740 configured to create the transport network slice, a computing component 750 configured to compute the transport network path, an assigning component 760 configured to assign the transport network path to the transport network slice, and an updating component 770 configured to update the transport network path based on network topology changes.

In some embodiments, the set of components may be separate and distinct from the TN controller performance monitoring component 182. In other embodiments, one or more components of the set of components may include or may be implemented within a controller/processor (e.g., the processor 120), a memory (e.g., the memory 130), or a combination thereof, of the device 100 described above in reference to FIG. 1. Alternatively or additionally, one or more components of the set of components may be implemented at least in part as software stored in a memory, such as the memory 130. For example, a component (or a portion of a component) may be implemented as computer-executable instructions or code stored in a computer-readable medium (e.g., a non-transitory computer-readable medium) and executable by a controller or a processor to perform the functions or operations of the component.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally or alternatively, a set of (one or more) components shown in FIG. 7 may perform one or more functions described as being performed by another set of components shown in FIG. 1.

Referring to FIG. 8, in operation, a network controller 700 may perform a method 800 of monitoring performance of network slices in a transport network by a network controller. The method 800 may be performed by the device 100 (which may include the memory 130 and which may be the entire device 100 and/or one or more components of the device 100, such as the processor 120, the input component 150, the output component 160, the communication interface 170, and/or the TN controller performance monitoring component 182). The method 800 may be performed by the TN controller performance monitoring component 182 in communication with the apparatus 708 (e.g., PMS 450 of FIGS. 4 and 5, the ingress PE 442, the ingress PE 542).

At block 802 of FIG. 8, the method 800 may include transmitting, to a network device of the transport network using a PCEP, a PCEP configuration message requesting rendering of a transport network path assigned to a transport network slice, the PCEP configuration message comprising a transport network slice identifier corresponding to the transport network slice and a slice status request requesting that the network device provide a status update of the transport network slice. For example, in an embodiment, the device 100, the TN performance monitoring component 180, the network controller 700, the TN controller performance monitoring component 182, and/or the transmitting component 710 may be configured to or may comprise means for transmitting, to a network device of the transport network 440 using a PCEP, a PCEP configuration message requesting rendering of a transport network path 445 assigned to a transport network slice, the PCEP configuration message comprising a transport network slice identifier corresponding to the transport network slice and a slice status request requesting that the network device provide a status update of the transport network slice.

For example, the transmitting at block 802 may include transmitting, to the network device, an extended PCEP PCInit message 610 and/or an extended PCEP PCUpd message 620, as described above in reference to FIG. 4. The extended PCEP message may include a slice object comprising the transport network slice identifier corresponding to the transport network slice and the slice status request requesting that the network device provide a status update of the transport network slice, as described above in reference to FIGS. 4 and 6.

In some embodiments, the transmitting at block 802 may include transmitting the PCEP configuration message to an ingress PE 442 of the transport network path 445. Alternatively or additionally, the transmitting at block 802 may include transmitting the PCEP configuration message to one or more network devices of the transport network 440, such as transit node 444A and transit node 444B.

Further, for example, the transmitting at block 802 may be performed to initiate the creation of a network slice that is associated with a slice identifier that may be used to monitor performance and/or status of the transport domain portion of the network slice.

At block 804 of FIG. 8, the method 800 may include receiving, from the network device, a first PCEP report message comprising first slice status information indicating whether the transport network slice is in an up state, whether a SLA of the transport network slice is met, and whether the transport network slice is in a down state. For example, in an embodiment, the device 100, the TN performance monitoring component 180, the network controller 700, the TN controller performance monitoring component 182, and/or the receiving component 720 may be configured to or may comprise means for receiving, from the network device, a first PCEP report message 630 comprising first slice status information indicating whether the transport network slice is in an up state, whether a SLA of the transport network slice is met, and whether the transport network slice is in a down state.

For example, the receiving at block 804 may include receiving, from the network device, an extended PCEP PCRpt message 630, as described above in reference to FIGS. 4 and 6.

In some embodiments, the receiving at block 804 may include receiving the first slice status information that has been determined according to one or more SR-PM messages received from one or more other network devices rendering the transport network path 445. The one or more other network devices may include transit node 444A, transit node 444B, and egress PE 446.

Further, for example, the receiving at block 804 may be performed to monitor performance of network slices in the TN domain 234 such that end-to-end performance of the network slice may be monitored. As a result, the PMS 450 may perform end-to-end monitoring of network slice performance, as well as, visualizations of the transport network paths. Thus, allowing for fault detection and isolation at an individual network slice and/or transport flow level.

At block 806 of FIG. 8, the method 800 may include reporting, to a PMS, the first slice status information of the transport network slice. For example, in an embodiment, the device 100, the TN performance monitoring component 180, the network controller 700, the TN controller performance monitoring component 182, and/or the reporting component 730 may be configured to or may comprise means for reporting, to a PMS 450, the first slice status information of the transport network slice.

For example, the reporting at block 806 may include reporting the first slice status information to the PMS via a first REST-API, as described above in reference to FIG. 4.

In some embodiments, the reporting at block 806 may include reporting, to a network slice management controller 310, the first slice status information of the transport network slice. Alternatively or additionally, the reporting, to the network slice management controller 310, of the first slice status information may include reporting the first slice status information to the network slice management controller 310 via a second REST-API.

Further, for example, the reporting at block 806 may be performed to report slice status information of the transport slice to a PMS 450. As a result, the PMS 450 may perform end-to-end monitoring of network slice performance, as well as, visualizations of the transport network paths. Thus, allowing for fault detection and isolation at an individual network slice and/or transport flow level.

In optional or additional embodiments that may be combined with any other embodiment, the method 800 may further include receiving, from a network slice management controller 310, a network slice creation request comprising a source address, a destination address, and the SLA. For example, in an embodiment, the device 100, the TN performance monitoring component 180, the network controller 700, the TN controller performance monitoring component 182, and/or the receiving component 720 may be configured to or may comprise means for receiving, from a network slice management controller 310, a network slice creation request comprising a source address, a destination address, and the SLA. Alternatively or additionally, the receiving of the network slice creation request may include receiving the network slice creation request via a REST-API.

In these optional or additional embodiments, the method 800 may further include creating, based on the network slice creation request, the transport network slice. For example, in an embodiment, the device 100, the TN performance monitoring component 180, the network controller 700, the TN controller performance monitoring component 182, and/or the creating component 740 may be configured to or may comprise means for creating, based on the network slice creation request, the transport network slice.

In these optional or additional embodiments, the method 800 may further include computing the transport network path according to the source address, the destination address, and the SLA. For example, in an embodiment, the device 100, the TN performance monitoring component 180, the network controller 700, the TN controller performance monitoring component 182, and/or the computing component 750 may be configured to or may comprise means for computing the transport network path according to the source address, the destination address, and the SLA.

In these optional or additional embodiments, the method 800 may further include assigning the transport network path to the transport network slice. For example, in an embodiment, the device 100, the TN performance monitoring component 180, the network controller 700, the TN controller performance monitoring component 182, and/or the assigning component 770 may be configured to or may comprise means for assigning the transport network path to the transport network slice.

In other optional or additional embodiments that may be combined with any other embodiment, the method 800 may include receiving, via at least one BGP-LS message, information indicating the one or more network topology changes. For example, in an embodiment, the device 100, the TN performance monitoring component 180, the network controller 700, the TN controller performance monitoring component 182, and/or the receiving component 720 may be configured to or may comprise means for receiving, via at least one BGP-LS message, information indicating the one or more network topology changes.

In these optional or additional embodiments, the method 800 may further include updating, based on one or more network topology changes, the transport network path to obtain an updated transport network path. For example, in an embodiment, the device 100, the TN performance monitoring component 180, the network controller 700, the TN controller performance monitoring component 182, and/or the updating component 770 may be configured to or may comprise means for updating, based on one or more network topology changes, the transport network path to obtain an updated transport network path.

In these optional or additional embodiments, the method 800 may further include transmitting, to the network device, a PCEP update message comprising the updated transport network path and another slice status request. For example, in an embodiment, the device 100, the TN performance monitoring component 180, the network controller 700, the TN controller performance monitoring component 182, and/or the transmitting component 710 may be configured to or may comprise means for transmitting, to the network device, a PCEP update message comprising the updated transport network path and another slice status request.

In these optional or additional embodiments, the method 800 may further include receiving, from the network device, a second PCEP report message comprising second slice status information indicating whether the transport network slice is in the up state, whether the SLA of the transport network slice is met, and whether the transport network slice is in the down state. For example, in an embodiment, the device 100, the TN performance monitoring component 180, the network controller 700, the TN controller performance monitoring component 182, and/or the receiving component 720 may be configured to or may comprise means for receiving, from the network device, a second PCEP report message comprising second slice status information indicating whether the transport network slice is in the up state, whether the SLA of the transport network slice is met, and whether the transport network slice is in the down state.

In these optional or additional embodiments, the method 800 may further include reporting, to the PMS, the second slice status information of the transport network slice. For example, in an embodiment, the device 100, the TN performance monitoring component 180, the network controller 700, the TN controller performance monitoring component 182, and/or the reporting component 730 may be configured to or may comprise means for reporting, to the PMS, the second slice status information of the transport network slice.

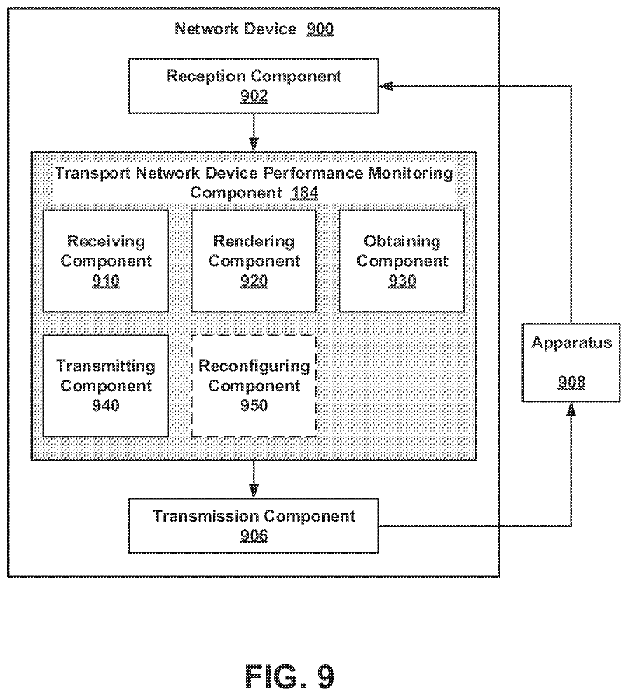

FIG. 9 is a block diagram of an example network device 900 for monitoring performance of network slices in a transport network. The apparatus 900 may be a computing device (e.g., device 100 of FIG. 1, ingress PE 542 of FIG. 5) or a computing device may include the apparatus 900. In some embodiments, the apparatus 900 may include a reception component 902 configured to receive communications (e.g., wired, wireless) from another apparatus (e.g., apparatus 908), a TN device performance monitoring component 184 configured to monitor performance of network slices in a transport network, and a transmission component 906 configured to transmit communications (e.g., wired, wireless) to another apparatus (e.g., apparatus 908). The components of the apparatus 900 may be in communication with one another (e.g., via one or more buses or electrical connections). As shown in FIG. 9, the apparatus 900 may be in communication with another apparatus 908 (such as the NSC 330 of FIGS. 4 and 5, a database, a server, or another computing device) using the reception component 902 and/or the transmission component 906.

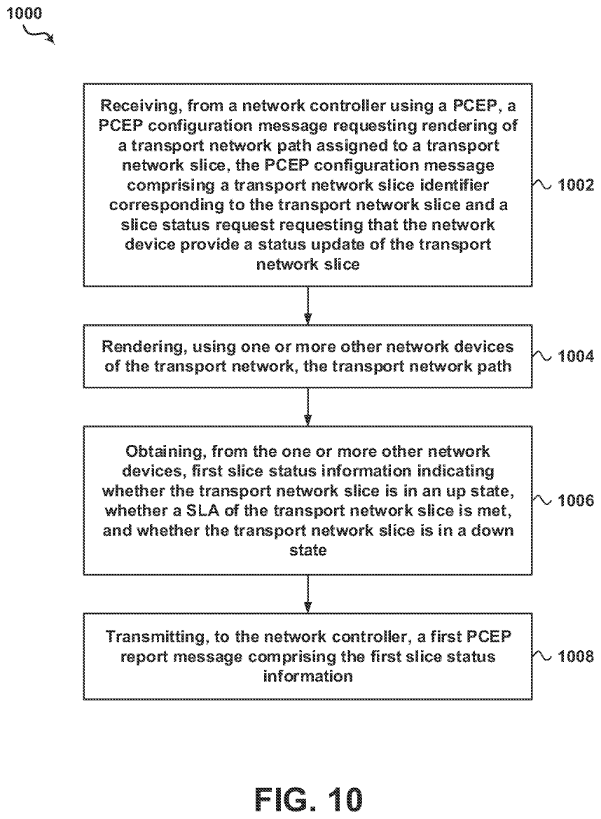

In some embodiments, the apparatus 900 may be configured to perform one or more operations described herein in connection with FIGS. 1-6. Alternatively or additionally, the apparatus 900 may be configured to perform one or more processes described herein, such as method 1000 of FIG. 10. In some embodiments, the apparatus 900 may include one or more components of the device 100 described above in connection with FIGS. 1-6.

The reception component 902 may receive communications, such as control information, data communications, or a combination thereof, from the apparatus 908 (e.g., the NSC 330 of FIGS. 4 and 5). The reception component 902 may provide received communications to one or more other components of the apparatus 900, such as the TN device performance monitoring component 184. In some aspects, the reception component 902 may perform signal processing on the received communications, and may provide the processed signals to the one or more other components. In some embodiments, the reception component 902 may include one or more antennas, a receive processor, a controller/processor, a memory, or a combination thereof, of the device 100 described above in reference to FIG. 1.

The transmission component 906 may transmit communications, such as control information, data communications, or a combination thereof, to the apparatus 908 (e.g., the NSC 330 of FIGS. 4 and 5). In some embodiments, the TN device performance monitoring component 184 may generate communications and may transmit the generated communications to the transmission component 906 for transmission to the apparatus 908. In some embodiments, the transmission component 906 may perform signal processing on the generated communications, and may transmit the processed signals to the apparatus 908. In other embodiments, the transmission component 906 may include one or more antennas, a transmit processor, a controller/processor, a memory, or a combination thereof, of the device 100 described above in reference to FIG. 1. In some embodiments, the transmission component 906 may be co-located with the reception component 902 such as in a transceiver and/or a transceiver component.

The TN device performance monitoring component 184 may be configured to monitor performance of network slices in a transport network. In some embodiments, the TN device performance monitoring component 184 may include a set of components, such as a receiving component 910 configured to receive a PCEP configuration message requesting a status update of the transport network slice, a rendering component 920 configured to render the transport network path, an obtaining component 930 configured to obtain slice status information, and a transmitting component 940 configured to transmit a PCEP report message with the slice status information.

Alternatively or additionally, the TN device performance monitoring component 184 may further include a reconfiguring component 950 configured to reconfigure at least one network device.

In some embodiments, the set of components may be separate and distinct from the TN device performance monitoring component 184. In other embodiments, one or more components of the set of components may include or may be implemented within a controller/processor (e.g., the processor 120), a memory (e.g., the memory 130), or a combination thereof, of the device 100 described above in reference to FIG. 1. Alternatively or additionally, one or more components of the set of components may be implemented at least in part as software stored in a memory, such as the memory 130. For example, a component (or a portion of a component) may be implemented as computer-executable instructions or code stored in a computer-readable medium (e.g., a non-transitory computer-readable medium) and executable by a controller or a processor to perform the functions or operations of the component.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 1.

Referring to FIG. 10, in operation, a network device 900 may perform a method 1000 of monitoring performance of network slices in a transport network by a network device. The method 1000 may be performed by the device 100 (which may include the memory 130 and which may be the entire device 100 and/or one or more components of the device 100, such as the processor 120, the input component 150, the output component 160, the communication interface 170, and/or the TN device performance monitoring component 184). The method 1000 may be performed by the TN device performance monitoring component 184 in communication with the apparatus 908 (e.g., NSC 330 of FIGS. 4 and 5).

At block 1002 of FIG. 10, the method 1000 may include receiving, from a network controller using a PCEP, a PCEP configuration message requesting rendering of a transport network path assigned to a transport network slice, the PCEP configuration message comprising a transport network slice identifier corresponding to the transport network slice and a slice status request requesting that the network device provide a status update of the transport network slice. For example, in an embodiment, the device 100, the TN performance monitoring component 180, the network device 900, the TN device performance monitoring component 184, and/or the receiving component 910 may be configured to or may comprise means for receiving, from a network controller using a PCEP, a PCEP configuration message requesting rendering of a transport network path assigned to a transport network slice, the PCEP configuration message comprising a transport network slice identifier corresponding to the transport network slice and a slice status request requesting that the network device provide a status update of the transport network slice.

For example, the receiving at block 1002 may include receiving, from the NSC 330, an extended PCEP PCInit message 610 and/or an extended PCEP PCUpd message 620, as described above in reference to FIG. 4. The extended PCEP message may include a slice object comprising the transport network slice identifier corresponding to the transport network slice and the slice status request requesting that the network device provide a status update of the transport network slice, as described above in reference to FIGS. 4 and 6.

In some embodiments, the network device of the transport network 440 is an ingress PE 422 device of the transport network path 445.

Further, for example, the receiving at block 1002 may be performed to initiate the creation of a network slice that is associated with a slice identifier that may be used to monitor performance and/or status of the transport domain portion of the network slice.

At block 1004 of FIG. 10, the method 1000 may include rendering, using one or more other network devices of the transport network, the transport network path. For example, in an embodiment, the device 100, the TN performance monitoring component 180, the network device 900, the TN device performance monitoring component 184, and/or the rendering component 920 may be configured to or may comprise means for rendering, using one or more other network devices of the transport network, the transport network path.

For example, the rendering at block 1004 may include rendering the computed transport network path 445 indicated by the configuration message received from the NSC 330, as described above in reference to FIG. 4. Further, for example, the rendering at block 1004 may be performed to configure the transport network 440 to implement the transport network slice indicated by the PCEP configuration message.

At block 1006 of FIG. 10, the method 1000 may include obtaining, from the one or more other network devices, first slice status information indicating whether the transport network slice is in an up state, whether a SLA of the transport network slice is met, and whether the transport network slice is in a down state. For example, in an embodiment, the device 100, the TN performance monitoring component 180, the network device 900, the TN device performance monitoring component 184, and/or the obtaining component 930 may be configured to or may comprise means for obtaining, from the one or more other network devices, first slice status information indicating whether the transport network slice is in an up state, whether a SLA of the transport network slice is met, and whether the transport network slice is in a down state.

For example, the obtaining at block 1006 may include transmitting, to the one or more other network devices, one or more SR-PM messages, as described above in reference to FIG. 4. The obtaining at block 1006 may further include receiving, from the one or more other network devices, responses to the one or more SR-PM messages comprising the first slice status information, as described above in reference to FIG. 4.

Further, for example, the obtaining at block 1006 may be performed to monitor performance of network slices in the TN domain 234 such that end-to-end performance of the network slice may be monitored. As a result, the PMS 450 may perform end-to-end monitoring of network slice performance, as well as, visualizations of the transport network paths. Thus, allowing for fault detection and isolation at an individual network slice and/or transport flow level.

At block 1008 of FIG. 10, the method 1000 may include transmitting, to the network controller, a first PCEP report message comprising the first slice status information. For example, in an embodiment, the device 100, the TN performance monitoring component 180, the network device 900, the TN device performance monitoring component 184, and/or the transmitting component 940 may be configured to or may comprise means for transmitting, to the network controller, a first PCEP report message comprising the first slice status information.

For example, the transmitting at block 1008 may include transmiting, using PCEP, a PCRpt message 630, as shown in FIG. 6, that has been extended to include the slice object identifying the transport network slice (e.g., TN-SliceID) and indicating the slice status of the transport network slice, as described above in reference to FIG. 4.

Further, for example, the transmitting at block 1008 may be performed to report slice status information of the transport slice. As a result, the PMS 450 may perform end-to-end monitoring of network slice performance, as well as, visualizations of the transport network paths. Thus, allowing for fault detection and isolation at an individual network slice and/or transport flow level.

In optional or additional embodiments that may be combined with any other embodiment, the method 1000 may further include receiving, from the network device, a PCEP update message comprising an updated transport network path and another slice status request. For example, in an embodiment, the device 100, the TN performance monitoring component 180, the network controller 700, the TN device performance monitoring component 184, and/or the receiving component 910 may be configured to or may comprise means for receiving, from the network device, a PCEP update message comprising an updated transport network path and another slice status request.

In these optional or additional embodiments, the method 1000 may further include reconfiguring, based on the updated transport network path, at least one network device of the one or more other network devices. For example, in an embodiment, the device 100, the TN performance monitoring component 180, the network controller 700, the TN device performance monitoring component 184, and/or the reconfiguring component 950 may be configured to or may comprise means for reconfiguring, based on the updated transport network path, at least one network device of the one or more other network devices;

In these optional or additional embodiments, the method 1000 may further include obtaining, from the one or more other network devices, second slice status information indicating whether the transport network slice is in the up state, whether the SLA of the transport network slice is met, and whether the transport network slice is in the down state. For example, in an embodiment, the device 100, the TN performance monitoring component 180, the network controller 700, the TN device performance monitoring component 184, and/or the obtaining component 930 may be configured to or may comprise means for obtaining, from the one or more other network devices, second slice status information indicating whether the transport network slice is in the up state, whether the SLA of the transport network slice is met, and whether the transport network slice is in the down state.

In these optional or additional embodiments, the method 1000 may further include transmitting, to the network controller, a second PCEP report message comprising the second slice status information. For example, in an embodiment, the device 100, the TN performance monitoring component 180, the network controller 700, the TN device performance monitoring component 184, and/or the transmitting component 940 may be configured to or may comprise means for transmitting, to the network controller, a second PCEP report message comprising the second slice status information.

The foregoing disclosure provides illustration and description, but is not intended to be exhaustive or to limit the implementations to the precise form disclosed. Modifications and variations are possible in light of the above disclosure or may be acquired from practice of the implementations.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method of monitoring performance of network slices in a transport network by a network controller, comprising:
transmitting, to a network device of the transport network using a path computation element communication protocol (PCEP), a PCEP configuration message requesting rendering of a transport network path assigned to a transport network slice, the PCEP configuration message comprising a transport network slice identifier corresponding to the transport network slice and a slice status request requesting that the network device provide a status update of the transport network slice;
receiving, from the network device, a first PCEP report message comprising first slice status information indicating whether the transport network slice is in an up state, whether a service-level agreement (SLA) of the transport network slice is met, and whether the transport network slice is in a down state; and
reporting, to a performance monitoring system (PMS), the first slice status information of the transport network slice.

2. The method of claim 1, wherein the PCEP configuration message comprises at least one of a PCEP initialization message and a PCEP update message.

3. The method of claim 1, further comprising:
receiving, from a network slice management controller, a network slice creation request comprising a source address, a destination address, and the SLA;
creating, based on the network slice creation request, the transport network slice;
computing the transport network path according to the source address, the destination address, and the SLA; and
assigning the transport network path to the transport network slice.

4. The method of claim 3, wherein the receiving of the network slice creation request comprises receiving the network slice creation request via a representational state transfer application programming interface (REST-API).

5. The method of claim 1, further comprising:
updating, based on one or more network topology changes, the transport network path to obtain an updated transport network path;
transmitting, to the network device, a PCEP update message comprising the updated transport network path and another slice status request;
receiving, from the network device, a second PCEP report message comprising second slice status information indicating whether the transport network slice is in the up state, whether the SLA of the transport network slice is met, and whether the transport network slice is in the down state; and
reporting, to the PMS, the second slice status information of the transport network slice.

6. The method of claim 5, further comprising:
receiving, via at least one border gateway protocol link state (BGP-LS) message, information indicating the one or more network topology changes.

7. The method of claim 1, wherein the first slice status information has been determined according to one or more segment routing performance monitoring (SR-PM) messages received from one or more other network devices rendering the transport network path.

8. The method of claim 1, wherein the network device of the transport network is an ingress provider edge (PE) device of the transport network path.

9. The method of claim 1, further comprising:
reporting, to a network slice management controller, the first slice status information of the transport network slice.

10. The method of claim 9, wherein
the reporting, to the PMS, of the first slice status information of the transport network slice comprises reporting the first slice status information to the PMS via a first representational state transfer application programming interface (REST-API), and
the reporting, to the network slice management controller, of the first slice status information comprises reporting the first slice status information to the network slice management controller via a second REST-API.

11. An apparatus for monitoring performance of network slices in a transport network, comprising:
a memory storage storing computer-executable instructions; and
a processor communicatively coupled to the memory storage, wherein the processor is configured to execute the computer-executable instructions and cause the apparatus to:
transmit, to a network device of the transport network using a path computation element communication protocol (PCEP), a PCEP configuration message requesting rendering of a transport network path assigned to a transport network slice, the PCEP configuration message comprising a transport network slice identifier corresponding to the transport network slice and a slice status request requesting that the network device provide a status update of the transport network slice;
receive, from the network device, a first PCEP report message comprising first slice status information indicating whether the transport network slice is in an up state, whether a service-level agreement (SLA) of the transport network slice is met, and whether the transport network slice is in a down state; and
report, to a performance monitoring system (PMS), the first slice status information of the transport network slice.

12. The apparatus of claim 11, wherein the PCEP configuration message comprises at least one of a PCEP initialization message and a PCEP update message.

13. The apparatus of claim 11, wherein the computer-executable instructions further cause the apparatus to:
receive, from a network slice management controller, a network slice creation request comprising a source address, a destination address, and the SLA;
create, based on the network slice creation request, the transport network slice;
compute the transport network path according to the source address, the destination address, and the SLA; and
assign the transport network path to the transport network slice.

14. The apparatus of claim 13, wherein the computer-executable instructions to receive the network slice creation request further cause the apparatus to receive the network slice creation request via a representational state transfer application programming interface (REST-API).

15. The apparatus of claim 11, wherein the computer-executable instructions further cause the apparatus to:
update, based on one or more network topology changes, the transport network path to obtain an updated transport network path;
transmit, to the network device, a PCEP update message comprising the updated transport network path and another slice status request;
receive, from the network device, a second PCEP report message comprising second slice status information indicating whether the transport network slice is in the up state, whether the SLA of the transport network slice is met, and whether the transport network slice is in the down state; and
report, to the PMS, the second slice status information of the transport network slice.

16. The apparatus of claim 15, wherein the computer-executable instructions further cause the apparatus to:
receive, via at least one border gateway protocol link state (BGP-LS) message, information indicating the one or more network topology changes.

17. The apparatus of claim 11, wherein the first slice status information has been determined according to one or more segment routing performance monitoring (SR-PM) messages received from one or more other network devices rendering the transport network path.

18. The apparatus of claim 11, wherein the network device of the transport network is an ingress provider edge (PE) device of the transport network path.

19. The apparatus of claim 11, wherein the computer-executable instructions further cause the apparatus to:
report, to a network slice management controller, the first slice status information of the transport network slice.

20. The apparatus of claim 19, wherein
the computer-executable instructions to report, to the PMS, of the first slice status information of the transport network slice further cause the apparatus to report the first slice status information to the PMS via a first representational state transfer application programming interface (REST-API), and
the computer-executable instructions to report, to the network slice management controller, of the first slice status information further cause the apparatus to report the first slice status information to the network slice management controller via a second REST-API.

21. A method of monitoring performance of network slices in a transport network by a network device, comprising:
receiving, from a network controller using a path computation element communication protocol (PCEP), a PCEP configuration message requesting rendering of a transport network path assigned to a transport network slice, the PCEP configuration message comprising a transport network slice identifier corresponding to the transport network slice and a slice status request requesting that the network device provide a status update of the transport network slice;
rendering, using one or more other network devices of the transport network, the transport network path;
obtaining, from the one or more other network devices, first slice status information indicating whether the transport network slice is in an up state, whether a service-level agreement (SLA) of the transport network slice is met, and whether the transport network slice is in a down state; and
transmitting, to the network controller, a first PCEP report message comprising the first slice status information.

22. The method of claim 21, wherein the obtaining of the first slice status information comprises:
transmitting, to the one or more other network devices, one or more segment routing performance monitoring (SR-PM) messages; and
receiving, from the one or more other network devices, responses to the one or more SR-PM messages comprising the first slice status information.

23. The method of claim 21, further comprising:
receiving, from the network device, a PCEP update message comprising an updated transport network path and another slice status request;
reconfiguring, based on the updated transport network path, at least one network device of the one or more other network devices;
obtaining, from the one or more other network devices, second slice status information indicating whether the transport network slice is in the up state, whether the SLA of the transport network slice is met, and whether the transport network slice is in the down state; and
transmitting, to the network controller, a second PCEP report message comprising the second slice status information.

24. The method of claim 21, wherein the network device of the transport network is an ingress provider edge (PE) device of the transport network path.

25. An apparatus for monitoring performance of network slices in a transport network, comprising:
a memory storage storing computer-executable instructions; and
a processor communicatively coupled to the memory storage, wherein the processor is configured to execute the computer-executable instructions and cause the apparatus to:
receive, from a network controller using a path computation element communication protocol (PCEP), a PCEP configuration message requesting rendering of a transport network path assigned to a transport network slice, the PCEP configuration message comprising a transport network slice identifier corresponding to the transport network slice and a slice status request requesting that the network device provide a status update of the transport network slice;
render, using one or more other network devices of the transport network, the transport network path;
obtain, from the one or more other network devices, first slice status information indicating whether the transport network slice is in an up state, whether a service-level agreement (SLA) of the transport network slice is met, and whether the transport network slice is in a down state; and
transmit, to the network controller, a first PCEP report message comprising the first slice status information.

26. The apparatus of claim 25, wherein the computer-executable instructions to obtain the first slice status information further cause the apparatus to:
transmit, to the one or more other network devices, one or more segment routing performance monitoring (SR-PM) messages; and
receive, from the one or more other network devices, responses to the one or more SR-PM messages comprising the first slice status information.

27. The apparatus of claim 25, wherein the computer-executable instructions further cause the apparatus to:
receive, from the network device, a PCEP update message comprising an updated transport network path and another slice status request;
reconfigure, based on the updated transport network path, at least one network device of the one or more other network devices;
obtain, from the one or more other network devices, second slice status information indicating whether the transport network slice is in the up state, whether the SLA of the transport network slice is met, and whether the transport network slice is in the down state; and
transmit, to the network controller, a second PCEP report message comprising the second slice status information.

28. The apparatus of claim 25, wherein the apparatus is an ingress provider edge (PE) device of the transport network path.
